(19) United States
(12) Patent Application Publication
(10) Pub. No.: US 2013/0020390 A1
(43) Pub. Date: Jan. 24, 2013

(54) PRODUCT ANTI-COUNTERFEIT SYSTEM

(71) Applicant: Gi Gi CHEN, Taipei (TW)

(72) Inventor: Gi Gi CHEN, Taipei (TW)

(21) Appl. No.: 13/543,847

(22) Filed: Jul. 8, 2012

(30) Foreign Application Priority Data
Jul. 22, 2011 (TW) 100126082

(51) Int. Cl. G06K 5/00

(52) U.S. Cl. 235/385

(57) ABSTRACT

A product anti-counterfeit system for full-range product monitoring management is disclosed. The system comprises a product managing device and at least one status control device. Each product has a product serial number and is provided with a corresponding RFID tag. When product status changes, the status control device is used to read the internal code from the RFID tag, to read or input product serial number and input the new product status for establishing a product pedigree. By using the status control device to read the internal code from the RFID tag and to check the product serial number and product pedigree, the authenticity of the product and the legality of the source can be determined.

### BACKGROUND OF THE INVENTION

The present invention is related to anti-counterfeit technology and more particularly, to a product anti-counterfeit system, which allows full-range product monitoring management.

In recent years, RFID (Radio Frequency Identification) technology has been improved continuously, and the scope of RFID application has also been expanded continuously.

Product management is an important application field of RFID technology. FIG. 1 illustrates an application of RFID technology in product management according to the prior art. According to this application, an RFID tag 12 is attached to the surface of a product 10 or its packaging 14. When the product 10 is purchased by a consumer, the product 10 is carried to the counter and scanned by an RFID tag reader (not shown), the RFID tag reader fetches product data for quick checkout.

After checkout, the RFID tag reader is controlled to transmit a signal to remove the anti-theft code from the RFID tag 12. Thus, the product 10 can pass the sensing of the sensor at the exit, allowing the consumer to carry the product out of the shop or hypermarket.

If any product that is not checked out is carried through the exit, the sensor at the exit will sense the anti-theft code of the RFID tag 12 and give an alarm for reminding staffs to take care.

This product management system provides a quick and smooth process for products 10 to check out, and provides the product 10 with an anti-theft function. However, the product data is stored in the RFID tag 12 and is able to be read without direct contact with the RFID tag reader. An evil person using the same model of RFID tag reader can illegally steal the product data of the product purchased by a consumer, this causes infringement of the consumer's personal privacy, or even threatens personal safety.

To overcome the abovementioned problem, some manufacturers may adhere the RFID tag 12 to the tearing line 141 on the product packaging 14. Thus, when the user uses the product 10 or opens the packaging 14 of the product 10, the RFID tag 12 is damaged for preventing the product data stored in the RFID tag 12 to be read by others. However, since the RFID tag 12 is damaged, the product 10 can no longer be identified and managed, and the function of anti-counterfeit is also disappeared. If the consumer is going to resale the product 10, he (she) may be unable to provide an effective certificate of authenticity.

### SUMMARY OF THE PRESENT INVENTION

It is an object of the present invention to provide a product anti-counterfeit system which allows full-range monitoring management.

It is another object of the present invention to provide a product anti-counterfeit system, which utilizes a product managing device and at least one status control device to manage and record product status and to form a product pedigree, achieving effective product management and recognition of product authenticity.

It is still another object of the present invention to provide a product anti-counterfeit system, wherein each product has one respective product serial number and is attached with an RFID tag storing an internal code. By matching the product serial number and the internal code, the recognition of product is achieved.

It is still another object of the present invention to provide a product anti-counterfeit system, wherein the product managing device comprises a product database for recording every status of each product for establishing a complete product pedigree for members to check.

It is still another object of the present invention to provide a product anti-counterfeit system, wherein the product managing device comprises a member database for storing member accounts and data, which can be combined with the product database to provide more powerful product control.

It is still another object of the present invention to provide a product anti-counterfeit system, wherein a member account is established when a user provides a user ID.

It is still another object of the present invention to provide a product anti-counterfeit system, wherein the user ID is selectively one of a national identity number, a passport number, a telephone number, a mobile phone number, an e-mail address, a business registration number, a user defined account, a specific account, or the combination thereof.

It is still another object of the present invention to provide a product anti-counterfeit system, wherein a password is sent to the purchaser by means of one of short message, e-mail, post, printing, voice and the combination thereof selectively, by the product managing device after the member account is created.

The present invention provides a product anti-counterfeit system, comprising: a plurality of products, each of said product having a product serial number; a plurality of RFID tags respectively corresponding to said products, each of said RFID tag having a respective internal code stored therein; a product managing device comprising a product database for storing the product serial number of each said product, the internal code of each said RFD tag corresponding to said product, and the related product information; and at least one status control device connected to said product managing device, each of said status control device comprising an RFID tag reader for reading the internal code stored in each RFID tag, reading or inputting the product serial number, inputting a new product status, and creating a corresponding product status data in said product database of said product managing device to form a product pedigree when the status of each said product is changed; wherein each of said status control device can be used to read the internal code of each of said RFID tag corresponding to said product for checking the internal code and product serial number for recognition of product authenticity.

### BRIEF DESCRIPTION OF THE DRAWINGS

FIG. 1 is a schematic drawing illustrating the product management with an RFID according to the prior art.

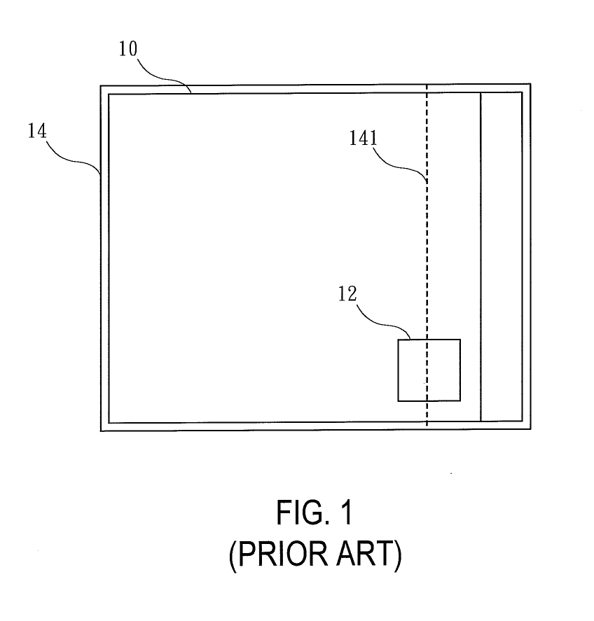

FIG. 2 is a schematic diagram showing the product anti-counterfeit system in accordance with one embodiment of the present invention.

FIG. 3 is a schematic drawing illustrating an example of product configuration in accordance with one embodiment of the present invention.

FIG. 4 is a schematic drawing illustrating an example of product configuration in accordance with another embodiment of the present invention.

### DETAILED DESCRIPTION OF THE PREFERRED EMBODIMENTS

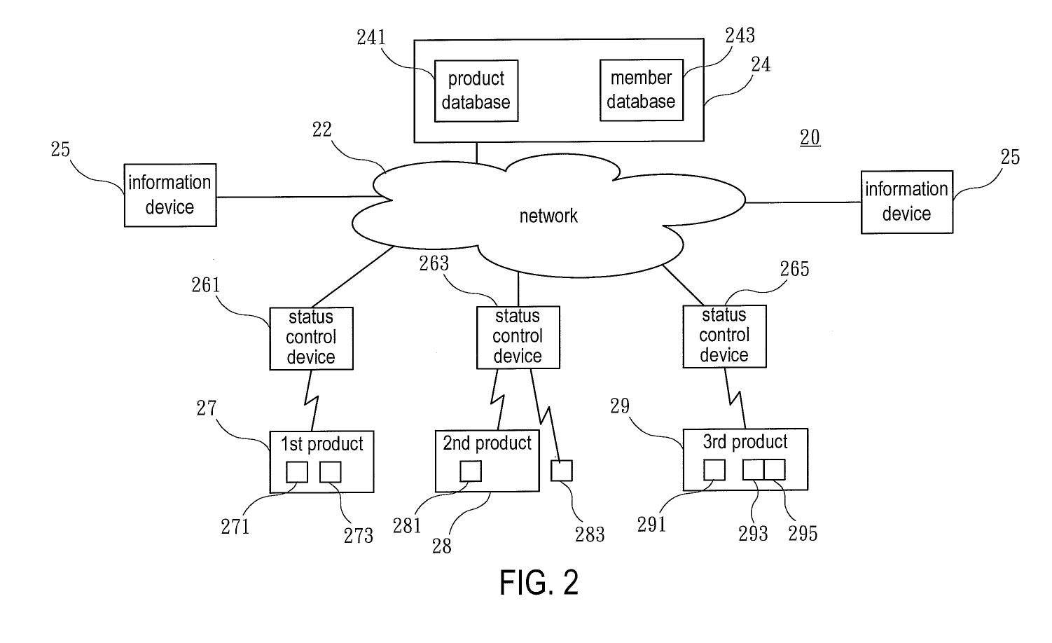

Please refer to FIG. 2, there is shown a product anti-counterfeit system 20 in accordance with one embodiment of the present invention. The product anti-counterfeit system 20 comprises a product managing device 24 and at least one status control devices, for example 261, 263 and 265. Each product (for example, first product 27, second product 28 and third product 29) has a respective product serial number 271, 281 or 291, and is equipped with a corresponding RFID tag 273, 283 and 293.

The status control devices 261, 263 and 265 are respectively connected to the product managing device 24. The product managing device 24 comprises a product database 241 for storing the product serial numbers 271, 281 and 291 of the products 27, 29 and 29, the internal codes of the corresponding RFID tags 273, 283 and 293 and the related product data.

The status control devices 261, 263 and 265 each comprise an RFID tag reader (not shown) for reading the internal codes stored in the RFID tags 273, 283 and 293. The status control devices 261, 263 and 265 can also read or input the serial number and product status of each product.

When the status of the product 27, 28 or 29 changes, for example, produced, stocked or delivered, for exhibition, reaching distributor or store, sold or resold, etc., the status control device 261, 263 or 265 is operated to read in the internal code of the respective RFID tag 273, 283 or 293, and to input the new status, consequently, a corresponding product status data is stored the product database 241 of the product managing device 24. The product status data contains the product's name, model, serial number, internal code, status (such as produced, stocked, delivered, exhibition, distributor, store, sold and resold), time and place.

According to the present invention, every product has a complete product pedigree with product status data of every stage. Thus, if the authenticity of the product is doubted during any stage, one can carry the product and the related RFID tag to the site where the status control device 261, 263 or 265 is provided and use the status control device 261 to read the internal code stored in the RFID tag and retrieve the product serial number stored the product database 241. Once the product serial number on the product matches the product serial number retrieved from the product database 241, the product is proved to be real.

After recognition of the authenticity of the product, the status of the product can also be checked with the product pedigree recorded in the product database 241 for determining whether the source of the product is legal or not.

In one embodiment of the present invention, the product managing device 24 further comprises a member database 243 for storing the member account and data. Further, membership can be obtained by two ways, one is obtained by means of purchasing the product, and the other is obtained by means of application for membership.

In the present invention, when a consumer purchases one product, the status control device 261, 263 or 265 is used to read the product serial number of the product and the internal code stored in the RFID tag for status update, and the product status data is recorded in the product database 241 of the product managing device 24. At this time, the purchaser can provide a user ID, such as a national identity number, a passport number, a telephone number, a mobile phone number, an e-mail address, a business registration number, a user defined account, a specific account, or the combination thereof. After the user ID is inputted, a member account is established in the member database 243 of the product managing device 24 for recording the corresponding member data, a relation between the product data and the member account is established, and the member account is recorded in the product status data.

When creates a new member account in the product managing device 24, the password of the member account is sent to the purchaser by means of one of short message, e-mail, post, printing, voice, or the combination thereof selectively. The purchaser can log into the product managing device 24 by inputting the user ID and corresponding password for account management, data inquiry, or other membership services. Further, when the purchaser is going to re-sell the product, the purchaser can go to the place where the status control device 261, 263 or 265 is provided to register the resale status, and the resale purchaser can provide the user ID to create a member account and become a member.

In one embodiment of the present invention, the RFID tag 273, 283 or 293 can be separately kept (like a guarantee card), adhered to the surface of the product, or combined with the product for different product management requirements.

In one embodiment of the present invention, every status control device 261, 263 or 265 can be connected to the product managing device 24 by a network, and every member can use an information device 25 to connect to the network for logging into the product managing device 24.

In one embodiment of the present invention, the product serial number of every product can be selectively represented by one of a character code, a barcode, a pattern, or the combination thereof.

In one embodiment of the present invention, every product (for example, product 29) can be equipped with an integrity recognition tag 295 which can be adhered to the seal of the package, the position for opening, or the position for using of the product. The integrity recognition tag 295 will be damaged when the product is unsealed, opened or used. If the status control device 265 cannot read the integrity recognition tag 295, it means the product has been unsealed, opened or used, and has lost its integrity.

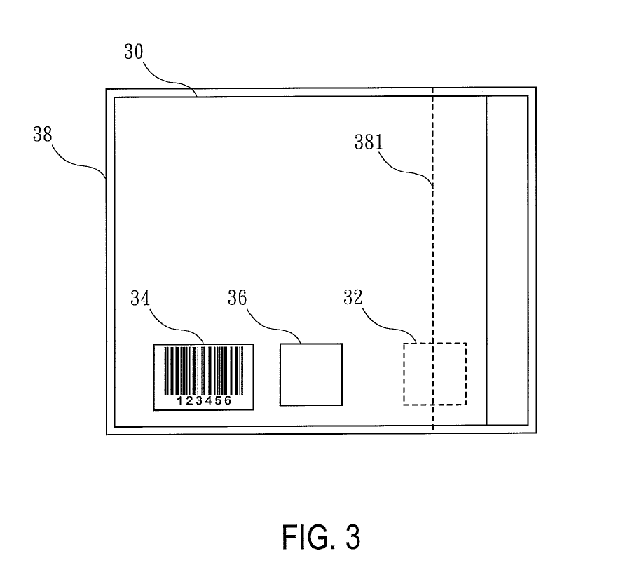

FIG. 3 illustrates an example of product configuration in accordance with one embodiment of the present invention. As illustrated, the product 30 of the present invention comprises a product serial number 34 and an RFID tag 36. The product serial number 34 is affixed to the product 30. The RFID tag 36 can be independently kept, adhered to the surface of the product, or combined with the product.

If there is a need for determination of the integrity of the product, an integrity recognition tag 32 can be adhered to the seal (such as the tearing line 381), position for opening, or position for using of the product. When unsealing, opening or using the product 30, the integrity recognition tag 32 will be damaged. Thus, by detecting the integrity recognition tag 32 is readable or not, the integrity of the product 30 is recognized. Certainly, the integrity recognition tag 32 should match the record in the product database.

Furthermore, even if the product 30 is unsealed, opened or used, the authenticity of the product can be recognized subject to the product serial number 34 and the internal code in the RFID tag 36. According to the product pedigree recorded in the product database of the product managing device, the legality of the source of the product 30 can also be recognized.

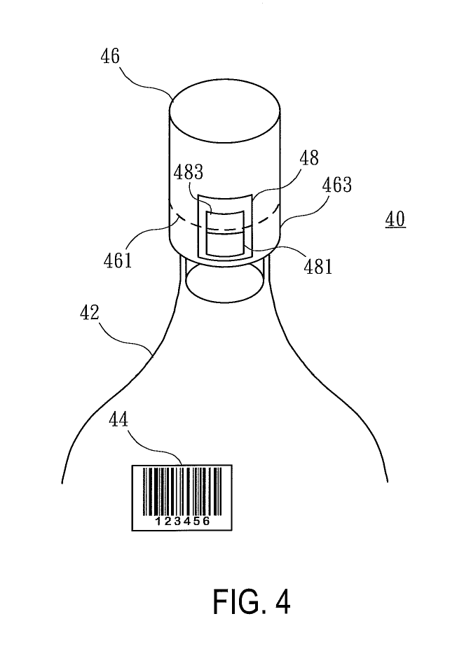

FIG. 4 illustrates an example of product configuration in accordance with another embodiment of the present invention. As illustrated, the product 40 is carried in a container 42 and sealed with a sealing cap (or sealing bottle cork) 46. The product 40 can be a bottled beverage, cosmetics, wine or perfume.

According to this application, an integrity recognition tag can be integrated into the RFID tag 48.

In this product 40 that is sealed with the sealing cap 46, the container 42 is marked with the product serial number 44, and the RFID tag 48 is adhered to the sealing cap 46. The RFID tag 48 comprises an internal code circuit 481 that has stored therein an internal code, and an integrity recognition circuit 483 that is adhered to the tearing line 461 of the sealing cap 46.

When opening the product 40, the sealing cap 46 is torn off at the tearing line 461 and then removed from the container 42. At this time, the integrity recognition circuit 483 of the RFID tag 48 is broken, and the internal code circuit 481 is maintained with the cuff 463 at the container 42. Thus, when use a status control device to read the RFID tag 48 after opening of the product 40, the internal code can be fetched for recognition of the authenticity of the product 40. Because the integrity recognition circuit 483 is damaged and no integrity recognition signal can be fetched, the product is recognized as having lost its integrity.

Using the product anti-counterfeit system 20 of the present invention can effectively recognize product authenticity as well as product integrity. Even if the product has been used and become a second-hand product, the system can still effectively recognize the authenticity of the product and trace the legality of the source of the product, completely stopping the selling of counterfeits and illegal trade.

What is claimed is:

1. A product anti-counterfeit system, comprising:
a plurality of products, each of said product having a product serial number;
a plurality of RFID tags respectively corresponding to said products, each of said RFID tag having a respective internal code stored therein;
a product managing device comprising a product database for storing the product serial number of each said product, the internal code of each said RFD tag corresponding to said product, and the related product information; and
at least one status control device connected to said product managing device, each of said status control device comprising an RFID tag reader for reading the internal code stored in each RFID tag, reading or inputting the product serial number, inputting a new product status, and creating a corresponding product status data in said product database of said product managing device to form a product pedigree when the status of each said product is changed;
wherein each of said status control device can be used to read the internal code of each of said RFID tag corresponding to said product for checking the internal code and product serial number for recognition of product authenticity.

2. The product anti-counterfeit system as claimed in claim 1, wherein the product status is selectively one of produced, stocked, delivered, exhibition, distributor, store, sold, or re-sold.

3. The product anti-counterfeit system as claimed in claim 2, wherein said product managing device further comprises a member database for storing a plurality of member accounts and member data.

4. The product anti-counterfeit system as claimed in claim 3, wherein each said status control device can be used for inputting a user ID of the purchaser when the product status is sold or re-sale, so that said product managing device stores said user ID in said product status data of the product database and creates a member account and member data in said member database corresponding to the purchaser.

5. The product anti-counterfeit system as claimed in claim 4, wherein said user ID is selectively one of a national identity number, a passport number, a telephone number, a mobile phone number, an e-mail address, a business registration number, a user defined account, a specific account, or the combination thereof.

6. The product anti-counterfeit system as claimed in claim 5, wherein said product managing device sends the password of the member account to the purchaser selectively by means of one of short message, e-mail, post, printing, voice, or the combination thereof when creates a new member account.

7. The product anti-counterfeit system as claimed in claim 1, wherein said product managing device is able to inquire the product status of each said product by reading the RFID tag corresponding to the product or inputting the product serial number of the product by means of said status control device.

8. The product anti-counterfeit system as claimed in claim 6, wherein said product managing device is connected with each of said status control device through a network.

9. The product anti-counterfeit system as claimed in claim 8, wherein each member is allowed to log into said product managing device through a network for inquiring product status.

10. The product anti-counterfeit system as claimed in claim 1, wherein said product serial number can be selectively represented by one of a character code, a barcode, a pattern, or the combination thereof.

11. The product anti-counterfeit system as claimed in claim 1, wherein each of said RFID tag is selectively to be kept separately, adhered to the surface of the product, or combined with the product.

12. The product anti-counterfeit system as claimed in claim 1, further comprising a plurality of integrity recognition tags respectively corresponding to said products, wherein each of said integrity recognition tag can be adhered to the seal of the package, the position for opening, or the position for using of the respective products.

13. The product anti-counterfeit system as claimed in claim 12, wherein each of said integrity recognition tag can be integrated in the corresponding RFID tag.
